(19) United States
(12) Patent Application Publication
(10) Pub. No.: US 2002/0002642 A1
(43) Pub. Date: Jan. 3, 2002

(54) Input and output systems for data processing

(76) Inventors: Peter John Tyson, Little London (GB); David William Bryant, Basingstoke (GB); Timothy Ian Shuttleworth, Reading (GB); Jeffery Richard Butters, Reading (GB)

Correspondence Address: Richard E. Fichter, BACON & THOMAS, PLLC, Fourth Floor, 625 Slaters Lane, Alexandria, VA, 22314, US

(21) Appl. No.: 09/828,183

(22) Filed: Apr. 9, 2001

(30) Foreign Application Priority Data
Apr. 7, 2000 (GB) 0008691.8

(51) Int. Cl. G06F 13/12; G06F 13/38

(52) U.S. Cl. 710/65

(57) ABSTRACT

The present invention relates to a method of processing video data comprising the transferral of the video data to a first memory buffer and the manipulation of video data. The manipulated video data is then transferred to a second memory buffer before being written to a plurality of discs.

### BACKGROUND OF THE INVENTION

This specification relates to input/output systems for computers and in particular to systems requiring high speed transfer of large volumes of data, such as the real time processing of television and video images, to data storage devices such as hard discs.

Computing systems have been known since the 1940's. These early computing systems had very little Input/Output, usually performing calculations of the sort where a few numbers were used in an algorithm that calculated a new ‘number’. An example of this is the calculation of a square root of a number, where one number (for example 2.0) is input, and the square root (1.414) is output.

Computing power has increased from these early days to the point where processor speeds have increased by six to ten orders of magnitude. Thus it now takes in the order of one millionth to one billionth of the time to implement an algorithm than it did in those early days The whole use of computer systems has expanded, and now there are cost beneficial applications for computer systems to process pictures. Such applications have involved the processing of individual pictures, for such industries as the printing industry. Recent advances in computing have made it desirable to harness the very fast computing power to process television pictures in real time, (that is at the same rate as television is broadcast). For Standard Definition television in Europe this is in the digital form of 625 lines, of which 576 have ‘active’ picture present. The picture lines in each of these frames consist of 720 picture elements, and at a frame rate of 25 frames per second. However in High Definition television the data rate is typically 1920 picture elements per line, 1080 lines, and a frame rate of 25 or 30 frames per second. This represents a total data rate of in excess of one Gigabit per second. Generally, computer systems have the power to process this data rate but are generally not sufficiently advanced to be able to sustain the Input/Output data rate necessary for High Definition Television in real time. This is the area of interest in this patent application

Whilst it is currently possible to obtain computer systems such as the ‘Onyx 2’ computer from Silicon Graphics Incorporated (SGI) of Mountain View, Calif., USA, these systems are extremely expensive, and are not cost efficient for Television production. Industry standard computers, such as the IBM compatible ‘PC’ range, using industry standard Operating systems, such as Window NT would be capable of forming the basis of a system for real time processing of HD Television data, if such a system is coupled to a purpose designed real time operating system with a suitable filing system. That is an object of at least preferred embodiments of the present inventions.

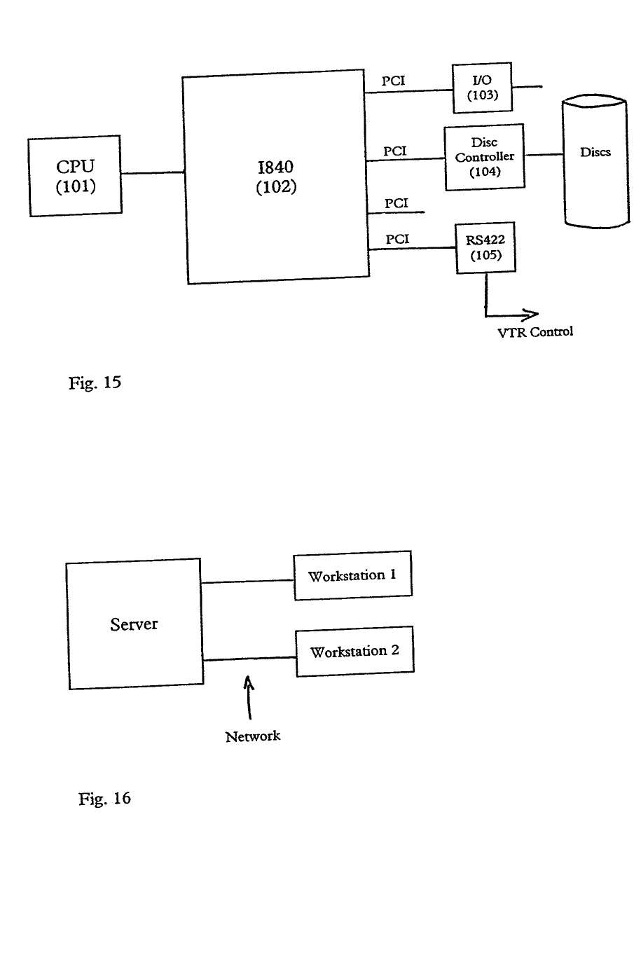

Several architectures are known to connect general purpose computers to video displays to display motion picture sequences on television. One such technique is shown in FIG. 15. A general purpose computer chip 101 such as an Intel Pentium is the CPU, and a chip 102 such as the Intel i840 is utilised as a controller chip. This architecture has a PCI bus architecture, with devices such as a video I/O card 103, a disc controller card 104 and an RS 422 card 105 for VTR control and the like. Typically the PCI bus will run at 32 or 64 bits bandwidth, and at 33 or 66 Mhz. The disadvantage of such systems is that all transfers from disc to video display are limited by the PCI bus bandwidth and by any non-essential activity

An alternative architecture that is well known is the ‘Server’ architecture, where a computer network is utilised to get pictures from a computer server disc to a display device, typically on another computer, as illustrated in FIG. 16. In this architecture it is usually the computer network that is the ‘bottleneck’ between the computer server and the display device. It is noted that whilst a great deal of effort is spent to ensure that servers have the maximum internal bandwidth, this is always much faster than the external network speed.

### SUMMARY OF THE INVENTION

According to a first aspect of an invention disclosed herein there is provided a method of processing video data comprising the sequential steps of:

(a) transferring the video data to a first memory buffer and manipulating said video data;

(b) transferring said manipulated video data to a second memory buffer; and

(c) writing said manipulated video data to a plurality of discs.

The manipulation of the video data preferably comprises dividing it into a plurality of blocks. The video data transferred to the first memory buffer may be in the form of two or more interlaced fields which are stored in an interlaced format in the first memory buffer. The methods described herein may be applied to sequential frame formats in which the video data is not supplied as interlaced fields. If however the data is stored as interlaced fields the block sizes are preferably selected such that a single block does not contain data from two adjacent fields as this would require that the same block be accessed for different portions of the video data. Preferably however the manipulation of the data includes the step of combining the interlaced fields so that they are stored sequentially in said first memory buffer before they are divided into blocks. This advantageously removes limitations on the block sizes which may be selected.

The blocks of video data are preferably grouped into chunks which are transferred to a plurality of disc stripe buffers in said second memory buffer. The blocks are preferably arranged such that consecutive blocks are not stored in the same disc stripe buffer. This may be achieved by taking a series of consecutive blocks of the video data and transferring each block in the series to a different disc stripe buffer in the second memory buffer. The number of blocks in the series is preferably the same as the number of disc stripe buffers in the second memory buffer and the manipulated video data in each disc stripe buffer is preferably written to a respective one of said plurality of discs. By ensuring that consecutive blocks of data are not stored in the same disc stripe buffer, any given portion of the video data is stored on more than one disc. Thus, the video data in that portion may be transferred between the disc stripe buffers and the discs more rapidly as a single disc is not responsible for transferring all of the data. The block sizes may be selected such that blocks containing adjacent video data in an adjacent field is not stored in the same disc stripe buffer.

When the blocks of data are transferred to the disc stripe buffer, the disc stripe buffers are preferably each filled consecutively. That is to say, the manipulated video data is preferably transferred to only one disc stripe buffer at a time. Furthermore, the manipulated video data contained within each disc stripe buffer is preferably only written to disc when the disc stripe buffer is full. The size of the disc stripe buffers is selected to maximise bandwidth transfer efficiency. The system used to store the video data and the parity data is preferably a RAID (Redundant Array of Inexpensive/Independent Discs) storage technique.

A set of parity data for the video data is preferably also generated during the step of manipulating the video data. Although the parity data may be transferred to each of the disc stripe buffers and written to the respective discs, it is preferably transferred to a parity buffer in said second memory buffer and subsequently written to a parity disc. A RAID storage technique may also be employed to store the parity data and this arrangement advantageously enables real-time reconstruction of missing or corrupted data. This is in comparison to, say, storing bank account data, which when there is an error is not time critical to deliver a customer's bank balance. The customer can easily wait a second for the bank balance, but in the delivery of video or television data, a delay of this magnitude to allow frames to be reconstructed would be totally unacceptable.

The video data is often stored as two 10-bit values, rather than the 8-bit bytes in which computer data is normally arranged. To reduce the number of empty bits the video data may be “packed” as it is stored. The level of packing is a compromise between the RAM utilisation to perform the necessary calculations and the storage benefits attained.

Although the system is not limited to a particular type of memory storage, the first memory buffer is preferably SRAM and the second memory buffer is preferably SDRAM.

The video data transferred to the first memory buffer is preferably at least a portion of a video image. It is further preferred that the video data transferred to the first memory buffer is a stripe of a video image, and a plurality of said stripes make up the video image.

The video image may be any form of standard definition television, High Definition (HD) television or film resolution image. In the case of a High Definition television image it is preferable to remove the synchronization and blanking pulses from the video image to allow the video data to fit into a 66 MHz bandwidth, which is a standard computer PCI bus bandwidth.

The present inventions further extend to methods of extracting video data from a plurality of discs wherein said video data has been manipulated and written to said discs in accordance with the methods described herein. The extraction of the video data from the plurality of discs typically includes the reversal of the processing steps employed to write the manipulated video data to the discs. The data may be further manipulated after it has been extracted from said discs to change the playout rate from that of the video data written to said discs. For example, the playout rate may be changed from 25 frames per second (which is the standard rate in Europe) to 30 frames per second (which is the standard rate in the United States) using a known method such as 3:2 pulldown.

Viewed from a further aspect there is provided a method of extracting video data from a plurality of discs comprising the sequential steps of: accessing manipulated video data on said plurality of discs; transferring said manipulated video data to a second memory buffer; converting said manipulated video data into video data and transferring the video data to a first memory buffer.

According to a further broad aspect of an invention disclosed herein there is provided a method of dividing a video image into a series of stripes which are each transferred to a separate first memory buffer which is connected to a plurality of disc drives.

The present inventions advantageously allow available bandwidth to be managed efficiently. This in turn offers substantial cost savings as the system uses the available buses efficiently, rather than have a greater number of buses (or faster buses) which are used inefficiently.

### BRIEF DESCRIPTION OF THE INVENTION

Some preferred embodiments of the present invention will now be described, by way of example only, with reference to the accompanying drawings in which:

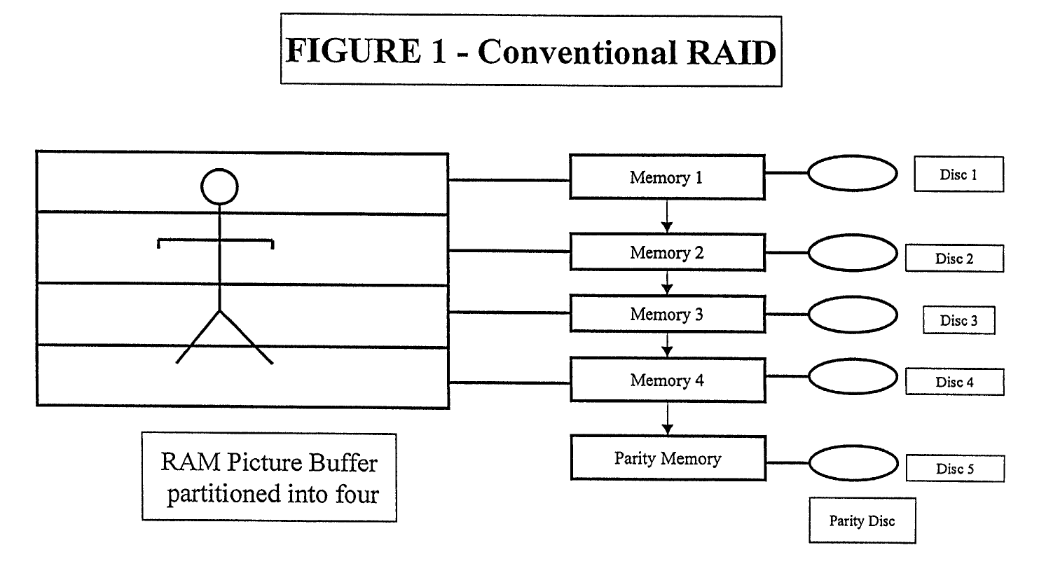

FIG. 1 shows a known technique of manipulating video data;

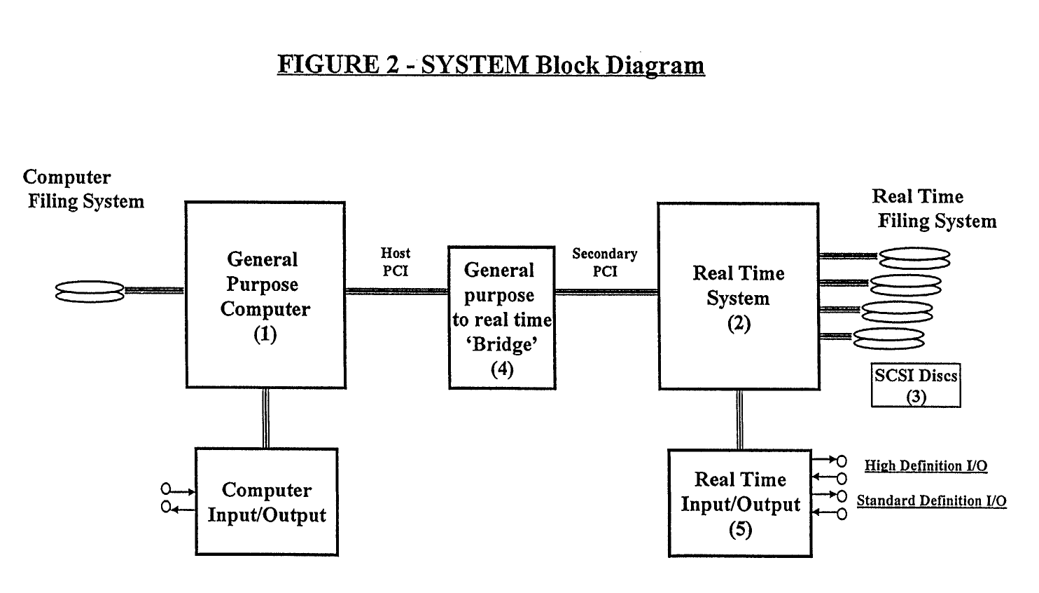

FIG. 2 shows a block diagram of the system according to the present invention;

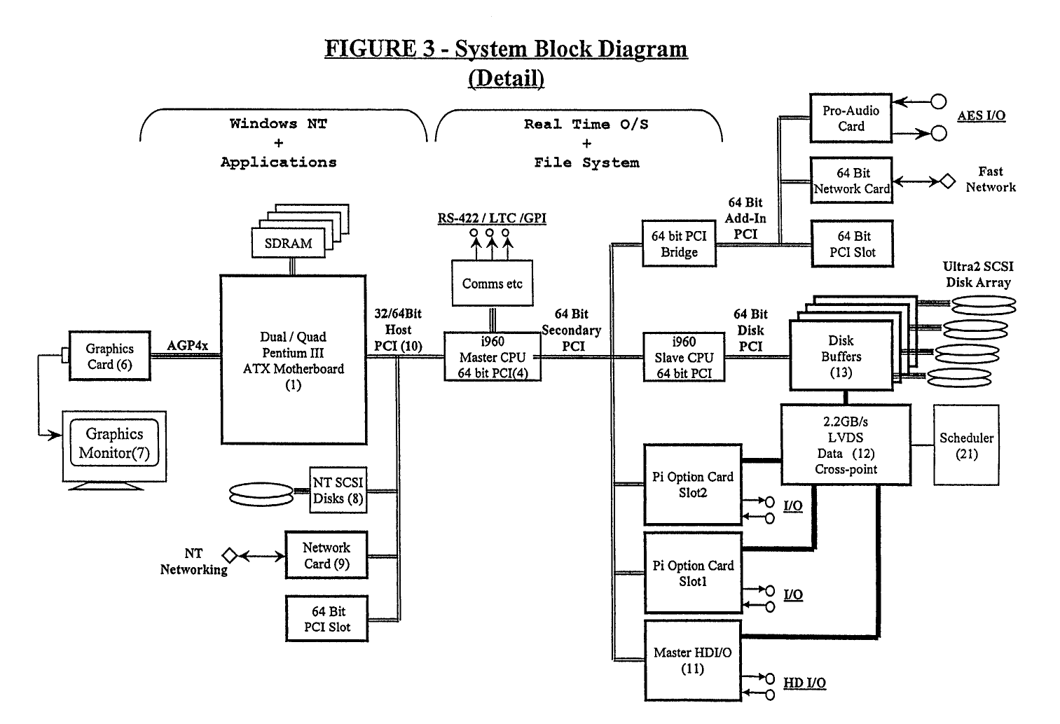

FIG. 3 shows a more detailed block diagram of the system shown in FIG. 2;

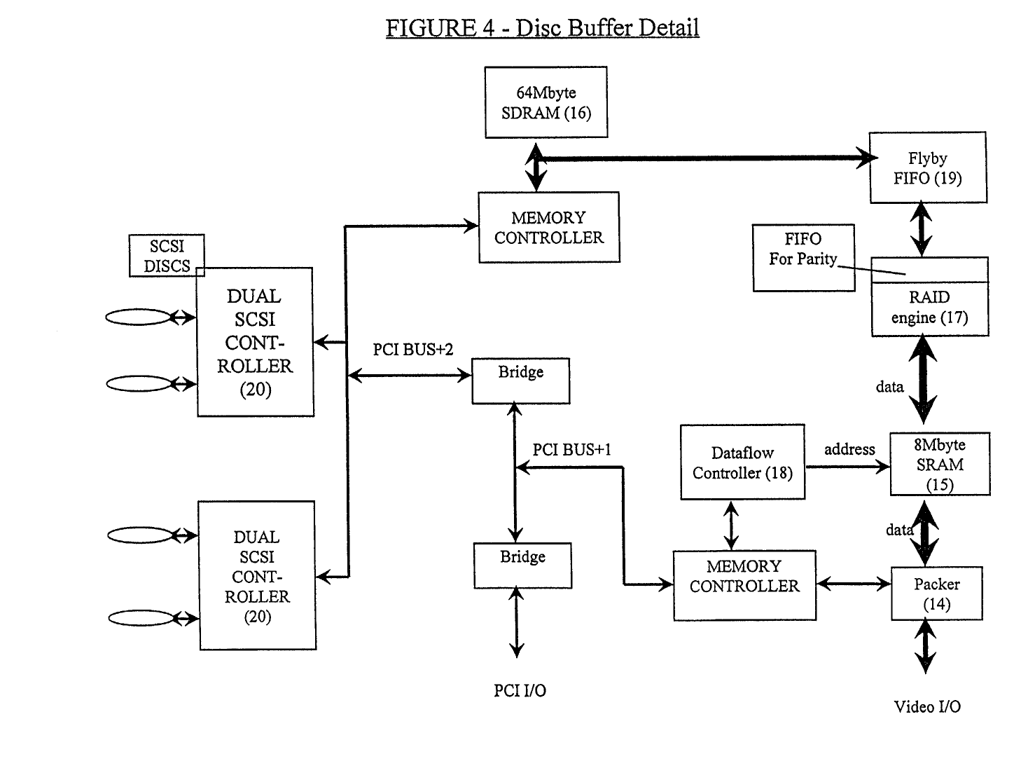

FIG. 4 shows details of the disc buffer according to the present invention;

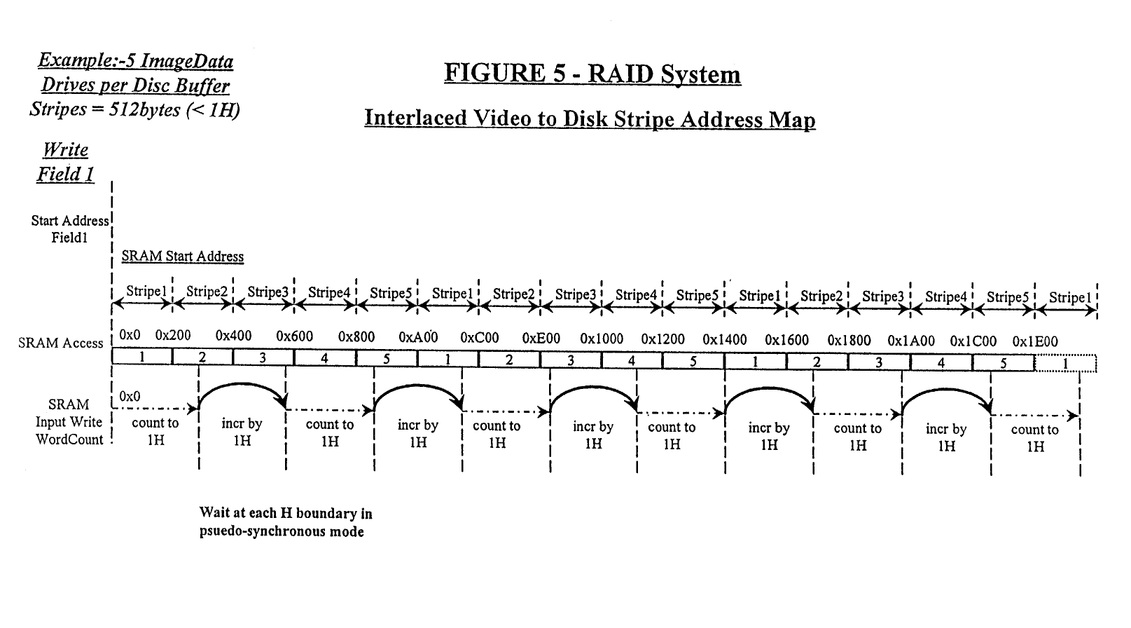

FIG. 5 shows the transfer of video data to a first memory buffer;

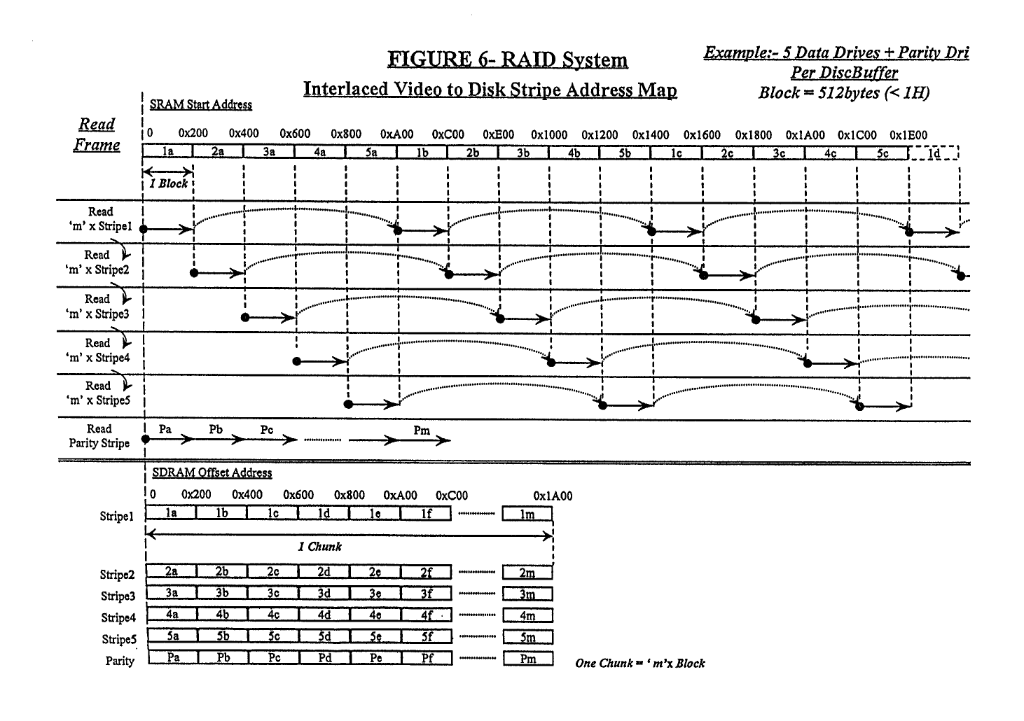

FIG. 6 shows the transfer of video data from the first memory buffer to a second memory buffer;

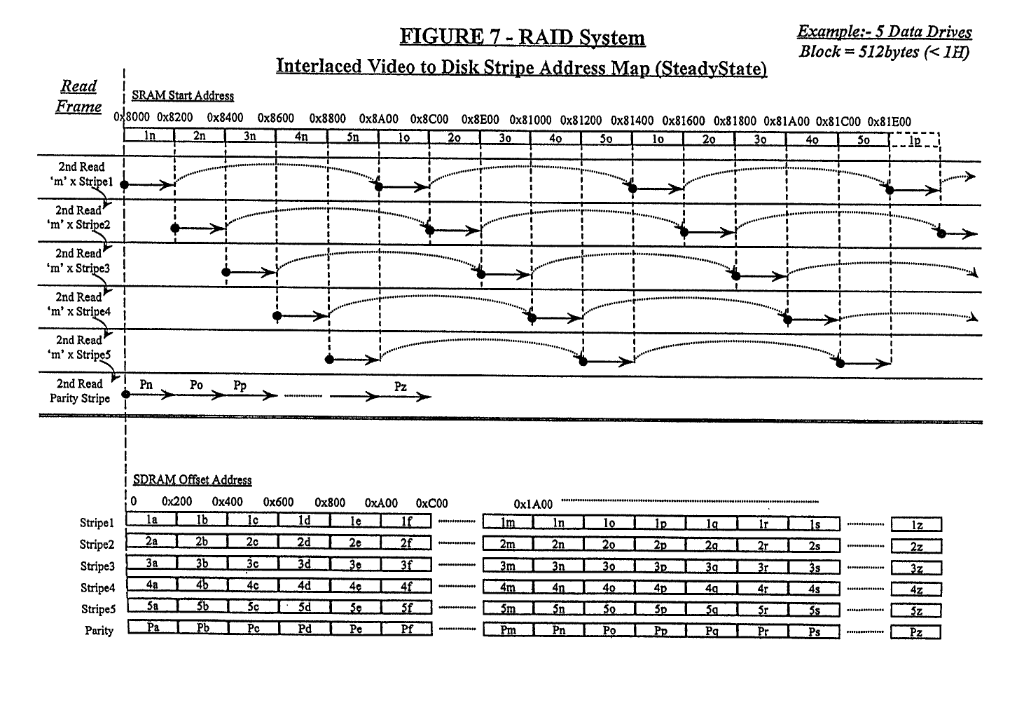

FIG. 7 shows the general arrangement for the transfer of video data from the first memory buffer to a second memory buffer;

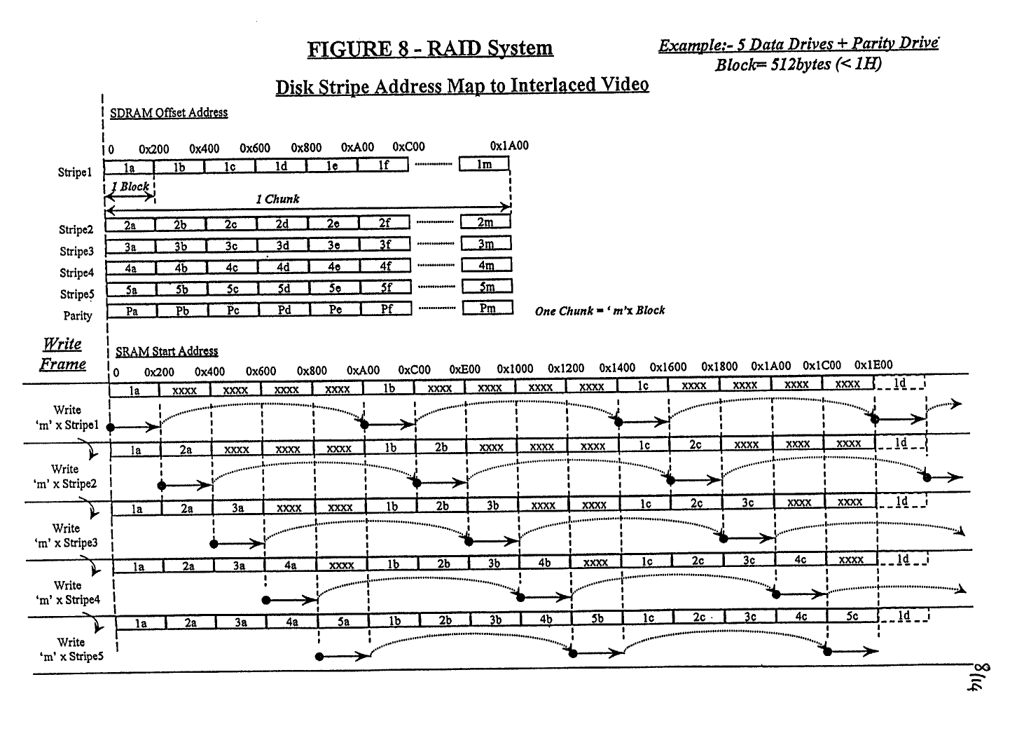

FIG. 8 shows the reading of video data from the second memory buffer to the first memory buffer;

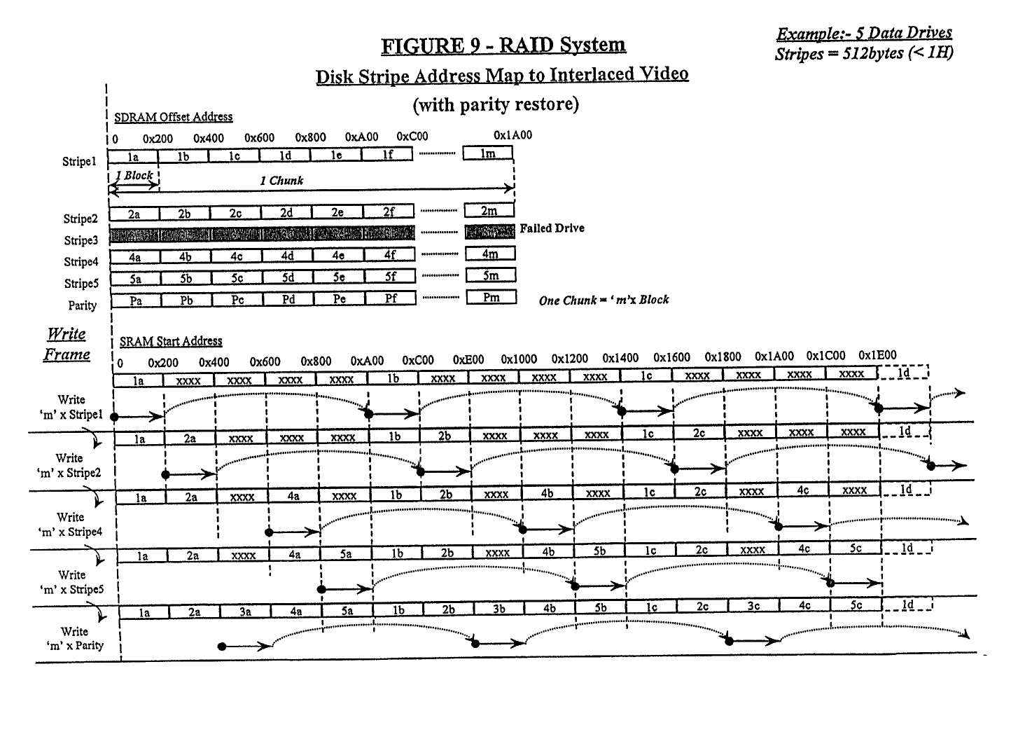

FIG. 9 shows the reconstruction of lost data from a parity buffer;

FIG. 10 shows a block diagram for the scheduler shown in FIG. 3;

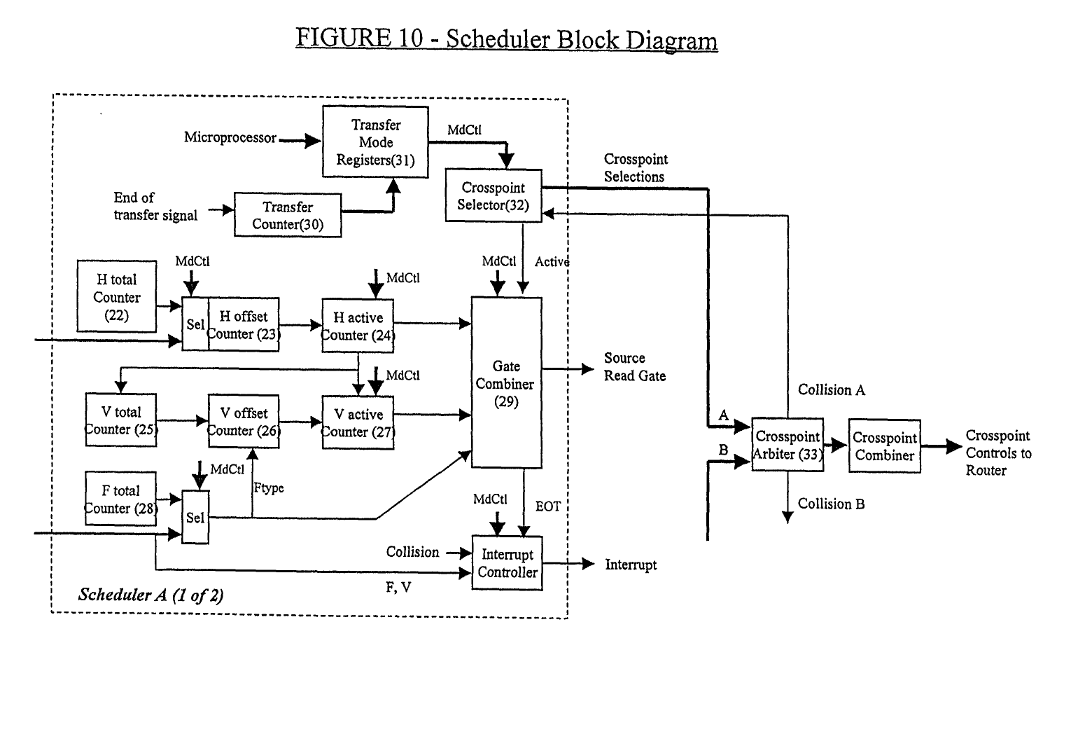

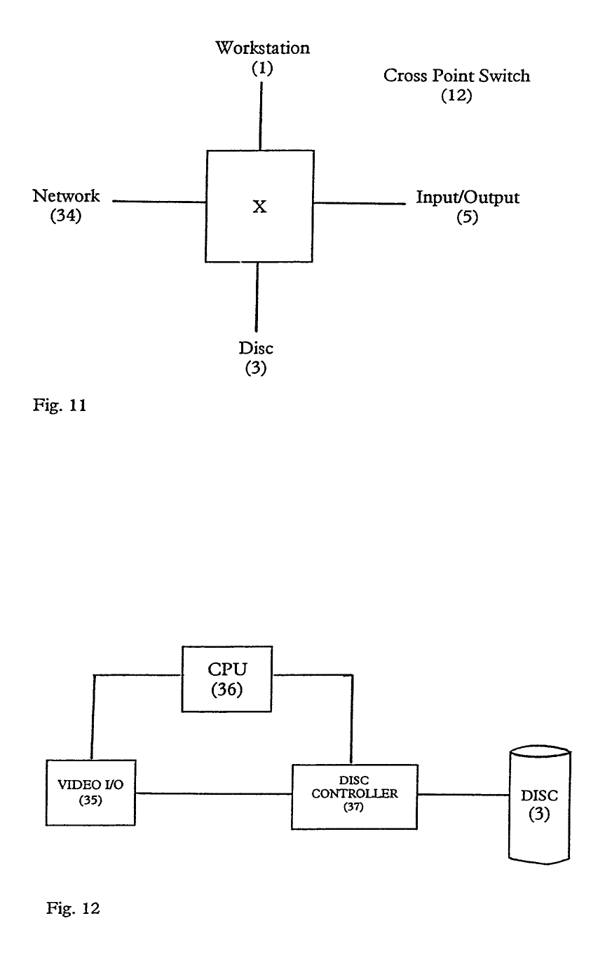

FIG. 11 shows a cross point switch;

FIG. 12 shows an arrangement for using a local processor to control video input/output transfers to the disc controller;

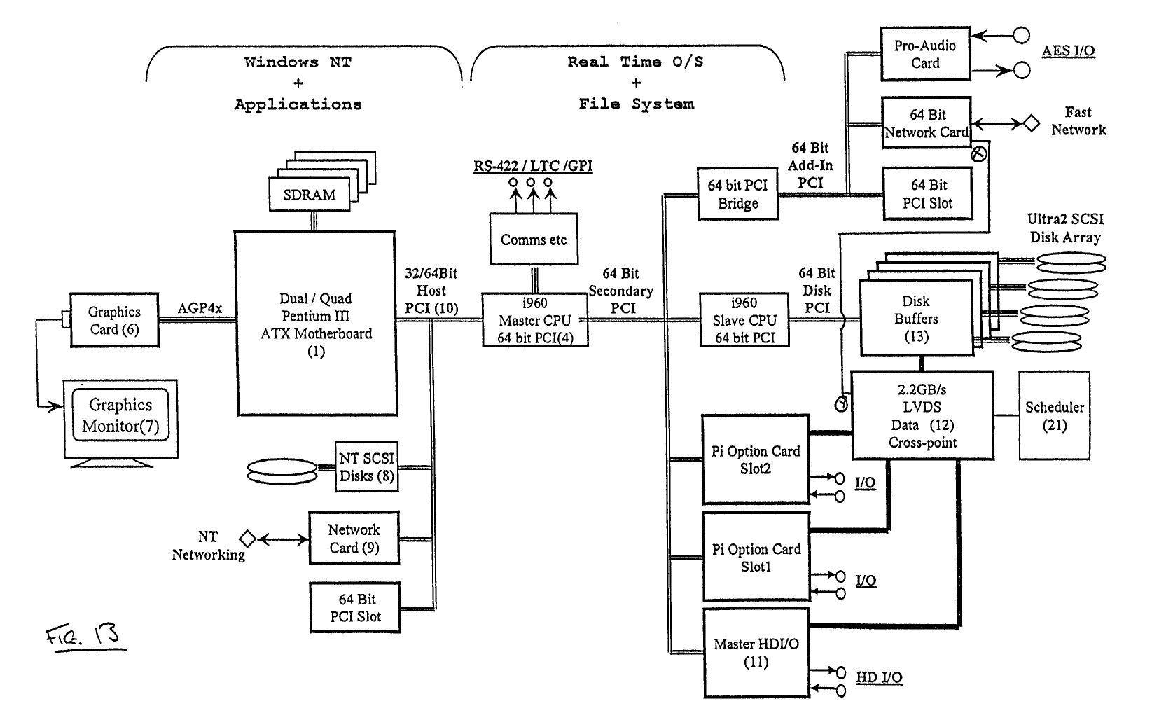

FIG. 13 shows an alternative embodiment of the present invention;

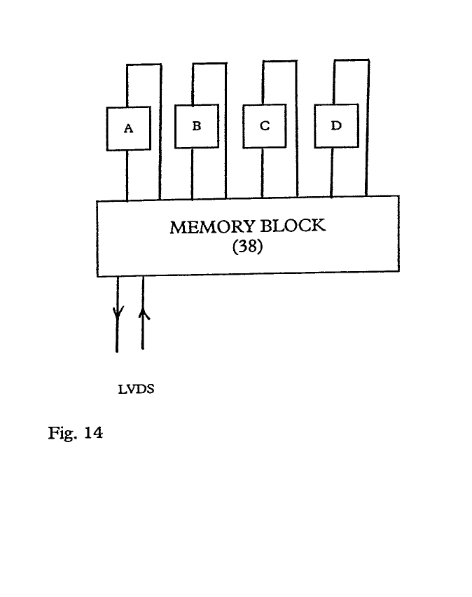

FIG. 14 shows a multi-processor architecture for a memory block;

FIG. 15 shows a known architecture to connect a general purpose computer to a video display; and

FIG. 16 shows a known architecture for connecting a video display to a computer network.

### DETAILED DESCRIPTION OF THE PREFERRED EMBODIMENTS

Referring first to a conventional method of writing data to disc arrays, as shown in FIG. 1. This data formatting technique is generally referred to as ‘RAID’ of which there are a number of specific categories, for example RAID 3. This technique splits the image data into a number of ‘stripes’, four in the present example shown in FIG. 1. These stripes are used to generate a ‘parity’ stripe and the four image stripes and the parity stripe are then each written to separate disc drives. To increase bandwidth of this formatting techniques requires that the number of discs (and stripes) be increased.

However, the conventional RAID data formatting technique has severe limitations when handling local areas of the video image as all of the data for a given region is stored on a single disc. For example, if the area of the image containing the face of the stick-man shown in FIG. 1 is to be retrieved from the storage device then the data for this region is all located on the first disc drive. Therefore, in order to access this data, the first disc drive must provide all of the information while the remaining disc drives remain idle. Thus transfer speed is dictated by the limitations of each disc drive. Of course, increasing the number of stripes and disc drives increases the bandwidth but again the required data will be contained in only some of the disc drives.

The inventors of the present application have identified that a ‘two stage’ striping architecture overcomes the limitations of traditional data formatting techniques. The method consists of the following steps. Firstly data is transferred to a first memory buffer, of a memory type that allows access to individual bytes. This maximises the efficiency of transfers between small disc blocks and large video data standards. Secondly, sections of this memory buffer are re-ordered and transferred to a second memory buffer, which in turn has an array of discs connected to it. Thirdly, data is written to these discs. Thus, the two stage striping allows the optimum use of a minimum number of discs of a given performance to give efficient ‘resolution independent’ storage. This allows the system to replay a variety of industry standard file formats in real time with no intermediate processing.

The architecture of the two stage system is generally shown in block diagram format in FIG. 2. A general purpose computer 1 with a commercially available operating system is connected to a custom ‘real time’ system 2, housing a real time disc system 3, via a ‘bridge’ 4. Input and output of standard definition television, High Definition (HD) television, and film resolution images is accomplished through a real time input and output system 5 connected to the real time system 2.

Thus, the general computer system 1 can access the image data as if it were a local storage volume, whereas in reality it is stored as a complex stripe structure on the real time part of the system 2 with the bridge 4 providing the necessary translation. Thus the limitations of conventional RAID data formatting are avoided as sequential blocks of data are stored on separate discs in the disc array 3. With this arrangement, when a portion of the video image is to be accessed from the disc array 3, for example the face portion of the stick-man shown in FIG. 1, sequential portions of the video format data are contained on separate discs 3. This allows the information to be read from a number of discs and ensures that a bottleneck is not created reading from a single disc. Thus the maximum possible usage of the disc array 3 is achieved avoiding the one disc bottleneck where RAID is much more difficult to implement.

Furthermore, the system can be dynamically reconfigured to maximise operational bandwidth in a number of modes. This is especially advantageous as modern day products may be expected to be working with Standard Definition pictures during the morning of an operational day, and may well be expected to be handling High Definition picture data that same afternoon. Thus, the flexibility of the present system allows operation in each of these modes. Advantageously, spare or surplus bandwidth can be allocated to other tasks, such as background non-real time accesses to the image data for manipulation by the processor. For example, whilst replaying a video clip in real time, other data can simultaneously be transferred in non-real time to other applications or networks.

The system described is essentially scalable to multiple formats, streams and resolutions. For example to the popular ‘dual link’ 4:4:4 RGB format. Furthermore, the two stage image striping technique allows for the hardware configuration of systems dependant on the bandwidth required. A minimal system can be factory configured with, for example, two memory buffers and disc systems, which can easily be ‘field upgraded’ to, for example, six or eight memory buffers and disc systems. Systems with say, two buffers are typical for standard definition video, with four or six buffers being suitable for High Definition Television. Six or more buffers may be optimal for ‘Film resolution’ data, consisting of 2000 lines or more resolution.

An additional advantage of the two stage striping method is that undetected disc errors will become less visually disruptive to the viewer who looks at the images. In the conventional techniques, as illustrated in FIG. 3, a large ‘frozen’ stripe will appear across the whole image width. In the proposed method, the ‘failure’ will be distributed evenly throughout the affected image stripe.

The architecture of the two stage system is shown in greater detail in FIG. 3. The general purpose computer 1 comprises a Dual/Quad Pentium III Processor, on an ATX motherboard and running a Windows NT Operating system. A graphics card 6 and a monitor 7 are attached, as is one or more SCSI discs 8 utilising an industry standard NTFS filing system. This computer may optionally be networked via a NT standard networking card 9.

The real time system 2 is interfaced to the Pentium III system of the general computer system 1 via a 32 bit Host PCI bus 4 (although alternative buses may be used such as a 64 bit version). The bridge 4 is through a CPU (Central Processing Unit), such as the Intel i960 64 Bit CPU, and has memory for data and for programs that it runs. The bridge 4 controls the communications and synchronisation between the general purpose computer 1 and the real time system 2. Thus, the two halves of the system may run asynchronously i.e. at different clock speeds, or in different phases. This architecture has the advantage of allowing a well known operator interface and operating system (Windows NT, for example) to be used, along with many industry standard software packages. Thus, the system can be easily upgraded in line with hardware and software developments, such as new developments in Pentium processing capabilities. This design handles the real time parts of the system using a real time operating system, such as ‘VxWorks’ (or ‘Ixworks’) from Wind River Systems Inc of California, USA.

The inventors of the present application have discovered several additional aspects which are beneficial in handling the exceptionally high data rates required for video images. Firstly, it is desirable to ‘strip’ the incoming data of synchronization and blanking pulses. This reduces the amount of data to be stored and, advantageously, allows ‘Television’ clock rates to be converted to ‘computer’ clock rates. It is widely accepted that High Density (HD) Television data is clocked at 74.25 Mhz, as derived from the relevant number of pixels, number of lines, and frame rate. However, this number is not a usual computer clock frequency but by removing the synchronisation pulses and blanking results, which are present in High Definition television data, the data can fit into a 66 MHz bandwidth. This is highly desirable, as Computer PCI buses come in 33 Mhz and 66 MHz bandwidth. Thus it is possible to transmit the HD picture, with synchronisation and blanking pulses removed, down either one 66 MHz PCI bus, or two 33 MHZ buses at 32 bits, or even 64 bits.

The most efficient place to strip the synchronisation and blanking pulses is in the I/O card 11. The stripped data from the I/O card 11 is then fed via an LVDS (Low Voltage Differential Signalling) system 12 to one of the disc buffer memory cards 13. The details of the disc buffer memory cards are shown in greater detail in FIG. 4.

Secondly, it is desirable to pack the data in an efficient computer manner, as opposed to ‘video format’. Representations in digital video form are often as two ten-bit values, the first ten bit value representing the luminance of a given pixel, followed by a ten bit value of one of the two chrominance values for that value. Pictures are commonly represented as luminance pixel 1, chrominance 1 value for pixel 1 and 2, luminance value 2, chrominance value 2 for pixels 1 and 2. Conversely, computer data is normally arranged as 8-bit bytes. The ‘repacking’ is typically to take 3 10-bit values, and concatenate them into a 30 bit sequence, occupying four consecutive bytes, with the last two bits empty. This level of packing represents a good compromise between complexity and efficiency of packing. Obviously, other packing algorithms can be used, for example, to ensure that every single bit is used, which has maximum overhead for the packing calculation but optimal use of RAM and Disc. Alternatively, there may be no packing of the data at all, which has no overhead calculation (as nothing happens) but also has no advantage in RAM utilisation. The packing algorithm selected can be carried out in such a hardware unit as the packer 14.

Considering now FIG. 4, there are two types of memory used. The first type is SRAM (Static Random Access Memory) 15 and the second is SDRAM (Synchronous Dynamic Random Access Memory) 16. Both have advantages. The SRAM 15 is more expensive, but faster and more flexible in writing and reading. It is said to have a ‘fine granularity’, being able to read and write individual ‘bytes’ on adjacent system clock cycles. The SDRAM 16 is cheaper, comes in ‘chips’ of larger capacity, and is inflexible in its addressing, and needs ‘refreshing’. The optimal arrangement is to firstly write the data into SRAM 15. The SRAM 15 allows the access needed for data re-ordering and for the RAID Engine 17 to generate the ‘parity’ stripe (outlined below), for which it is necessary to perform non sequential accessing to individual bytes as well as allowing access to parts of the image for CPU processing. This can be used for example, for concurrent access to RAID protected data on the disc array 3 for transferring part or all of images over the external computer network.

Parity techniques are well known in disc storage technology. The typical techniques used in these parity checks are to carry out an ‘exclusive or’ operation on the matching elements in each memory buffer. As a simple example, if there are two memory buffers, each of six elements, there would be a separate parity buffer, containing the ‘exclusive or’ of the respective elements of the buffers.

### EXAMPLE

Memory buffer 1 101100

Memory buffer 2 011010

‘Exclusive Or’ of respective elements 110110

Utilising parity techniques, if one or more elements is missing from any one buffer, performing an ‘exclusive or’ on the respective values enables reconstruction of the missing values. This technique is expandable to buffers of any length, and for more than two buffers. In practice to sustain high definition television data rates it is necessary to carry out this operation at a total data rate of approximately 300 Mbytes per second. This technique causes ‘data expansion’ as it is necessary to store the parity stripe in addition to the original data from which the parity stripe is created and, thus, should be optimised for large quantities of data.

It is common that disc drives write a minimum amount of data to a disc, commonly being a ‘disc block’ of 512 bytes. In a simple case, where one digit (or byte) is to be stored, each disc drive writes a disc block, and a parity block is written on the parity drive. Thus in total, for an example with five stripes and a parity stripe, it is necessary to write six disc blocks of data for the one digit to be recorded. Whilst this expansion would not be tolerated in systems with little input & output, in a system with striped image files running into hundreds of gigabytes the expansion or inefficiency is minimal.

Much performance advantage can be gained by this two stage architecture of data formatting. The more close coupled the two systems are, the more efficient the whole. Several examples of this ‘close coupling’ are given below:

The process of transferring video format into a single SRAM 15 disc buffer will now be described with reference to FIG. 5. In this example, the data for a single image stripe is to be transferred to the disc buffer which is connected to five data disc drive array 3 and a parity disc drive (although there will be typically two to eight of these disc buffers, each handling one ‘image stripe’). The video format to be transferred to the disc drive buffer is from a conventional television picture which is typically updated as two interlaced ‘fields’. There is typically a first field, consisting of the ‘odd’ numbered lines (1, 3, 5, 7, etc), referred to as the ‘odd’ field, and a second field consisting of the ‘even’ numbered lines (2, 4, 6, 8, etc), referred to as the ‘even’ field. Typically in the European system of broadcast, the odd field is updated in the first 20 Milliseconds, and then in the next 20 Milliseconds the even field is updated. This method is used to portray reasonable motion with half the bandwidth or data rate than would be taken if every frame was transmitted every 20 Milliseconds.

The first field of video format, either odd or even, is input into the SRAM 15 line by line. However, rather than inputting the odd lines or even lines sequentially, once each line has been input the SRAM address increments by one line length H to leave a space equal to a line length, as shown in FIG. 5. Once the first field of video format has been input, the second field is input into the spaces left between the lines of the first field. Thus, rather than the first field of video format being input as a first block and then the second field as a second block, the lines are transformed from interlaced to sequential in the SRAM 15. The line lengths of the video format are also generally longer than the disc block sizes (512 bytes) and thus each line is written into more than one disc block. The sequence of writing ‘Stripes’ from video format to the SRAM 15 are under the control of the data flow controller 18.

The video format data stored in the SRAM 15 is then transferred in ‘chunks’ (meaning the data represented by ‘m’ blocks) to SDRAM 16 and then to disc 3, as shown in FIG. 6. In order to write to disc efficiently each of the disc stripe buffers must be filled. Therefore to maximise efficiency of each disc it is important to fill each disc stripe buffer quickly so that it can be written to disc. The first ‘block’ of data, block 1a, is read from the SRAM buffer 15, and written to a first disc stripe buffer (Stripe1). To fill disc stripe buffer 1 (Stripe1), the next block to be read is block 1b which is read and written contiguously to block 1a in the SDRAM 16. In the present arrangement the number of blocks to be skipped when reading blocks, which are to be written contiguously into the disc stripe buffers, is four which is the number of data drives minus 1. Thus if the number of discs is ‘D’, then for the first disc stripe buffer (Stripe1) the block addresses 1, 1+D, 1+2D, 1+3D etc are read. This is repeated until the first disc stripe buffer (Stripe1) is full and its contents are then written to a first disc D1 and the process of filling the second disc stripe buffer (Stripe2) is commenced. For five image data drives, this is done by reading the second block, the seventh block, the twelfth block, and so on. In a generalised case with ‘D’ Image drives, to fill the second stripe buffer (Stripe2) the block addresses 2, 2+D, 2+2D, 2+3D, etc are read. When the second stripe buffer (Stripe2) is full the contents are written to a second disc D2. This is repeated for the third, fourth, and fifth stripes under control of the data flow controller 18.

FIG. 7 shows the same arrangement as FIG. 6, but for a generalized part of the buffer, not the start of the buffer.

The parity data is written to the SDRAM 16 in chunks, in the same way as the image data, and then written sequentially to parity disc in the disc array 3, as shown in FIG. 6. Values for ‘m’ can be between 1 and an integer number that makes the chunk equal to the size of the Parity FIFO 19. This chunk size is a parameter that can be used to optimise or ‘tune’ system performance. If m=1, then a lot of small transfers to SDRAM 16 and disc will take place, and there will be a lot of associated overhead. If m is large, fewer (but bigger) transfers will take place. This has the advantage of less overheads, as the number of transfers is smaller, but longer periods when the system may be unresponsive as transfers are taking place.

The process of reading from disc 3 to memory, as shown in FIG. 7, is the reverse of the writing process. Disc data is read by the SCSI controller 20 to chunks (of ‘m’ disc blocks) into the SDRAM disc stripe buffers. The SCSI transfers are not locked to a particular chunk size, and the chunk can be read in one or more SCSI transfers. A SCSI transfer could also be in excess of a chunk. The important factor is to have a separate optimal parameter for SCSI transfer size that may or may not be the same as the memory chunk size. The contents of the first block 1a of the first disc stripe buffer (Stripe1) are written to the first block of SRAM 15. The second block 1b of the first disc stripe buffer (Stripe1) is written as the sixth block of SRAM 15, the third block 1c as the eleventh block of SRAM, and so on. Similarly, the first block 2a of the second disc stripe buffer (Stripe2) becomes the second block of SRAM 15, the second block 2b of the second disc stripe buffer (Stripe2) becomes the seventh block of SRAM 15, and so on.

In reading and writing to and from the disc 3, the ‘read chunk’ can be a different size to the ‘write chunk’. Also, it is possible to alter the size of both the ‘read chunk’ and ‘write chunk’ dynamically. Factors that may affect the dynamic changing of these ‘chunk’ sizes include the general ‘business’ of the system, the amount of retries being executed by the system, and disc latency with the particular discs being used.

The restoration of data from the parity stripe disc, as required upon failure of a disc, is shown in FIG. 9. To restore the data from the parity disc it is necessary to first identify which disc has failed Normally the failure of the disc is known because of a reported error from a disc controller 20. Alternatively, the parity may be continuously monitored to detect errors that the disc controller does not report In the present illustration, disc drive 3 becomes unreadable and thus some or all of the data contained thereon is invalid. The data from disc 1 is read into the first disc stripe buffer (Stripe1), the data from disc 2 into the second disc stripe buffer (Stripe2) and so on for the fourth and fifth discs. The contents of the parity disc are also written to the parity disc stripe buffer (parity). As the third disc has failed it is not possible to reliably read the data into the third disc stripe buffer (Stripe3).

The first block 1a of the first disc stripe buffer (Stripe1) is read to the first block of SRAM, the second block 1b to the sixth block, and so on. The first block 2a of the second disc stripe buffer (Stripe2) is then read to the second block of SRAM, the second block 2b to the seventh block, and so on. After repeating these reading steps for the fourth disc stripe buffer (Stripe4) and the fifth disc stripe buffer (Stripe5), the contents of the parity disc stripe buffer (parity) are read into the third, eighth, thirteenth blocks of SRAM and so on. The RAID engine 17 then performs the ‘exclusive or’ operations to recreate ‘in situ’ in the SRAM 15 the missing data. The same overall amount of data is transferred from SDRAM to SRAM, so a reconstructed frame transfer takes exactly the same time as normal operation, i.e. there is no overhead.

Considering now the strategy for performing real-time transfers between storage and interface nodes, with reference to FIG. 3. There are two main mechanisms used to carry this out. The first is the data crosspoint router 12. This system has three bus pairs, and is capable of handling data either as a computer format ‘32 bit’ data path, or in video format known as ‘4:4:4’, as defined by Recommendation 601 of the ITU (International Telecommunications Union) standardisation organisation. The router 12 consists of two logical halves. On the one side the Input/Output has a ‘star’ formation of LVDS (Low Voltage Differential Signalling) which operates in a Unidirectional mode to any one node. The other ‘side’ of the router 12 is connected to the disc buffer 13 in a bi-directional mode.

In a further enhancement, it is desirable to be able to route data from one disc buffer 13 to another, to allow processing (if desired) between buffers. One application that this is particularly useful for is to store ‘Key’ information in a 4:2:2 mode. Video ‘Keys’ are normally image planes that are designated to ‘switch’ between source images. In a simple example, it may be desirable to insert part of one image inside the image area of another image. This is sometimes referred to as ‘picture in picture’. In this mode there are two ‘source images and a ‘key’ image. For a generalised picture element in line L and pixel P, the value of the element at Line L and Pixel P in the ‘key’ image will determine whether the first source pixel (at Line L and Pixel P in the first source image) is present in that position in the output (composite) image, or whether the contents of the second source image at Line L and Pixel P is present. One nomenclature is that the value ‘0’ present in the key image may mean select image 1 at that point, and the value ‘1’ in the key image may mean select source image 2 at that point. Now the commonly defined Recommendation 601 of the ITU defines data in two formats, referred to as ‘4:2:2’ and ‘4:4:4:4’. In the first format (4:2:2) the ‘4’ value represents the sampling frequency of the luminance signal, and the ‘2’ values refer to the sampling frequency of the chrominance signals. Thus the luminance signal is sampled at twice the frequency of the chrominance. In the second of these formats, each of the channels of the image (usually Red, Green, Blue and ‘Key’) is sampled at the same rate. In the first of these formats no facility is provided for storing ‘key’ signals. Thus it is desirable to convert the ‘key’ image (when present) to a ‘pseudo 4:2:2’ image, by copying the ‘key’ values into the luminance channel of an ‘empty’ image, making a ‘4:0:0’ image. This can also be done by reading from one disc buffer, modifying the data (if desired), and writing back to the same disc buffer.

The control of this router is carried out by two or more transfer schedulers 21. These schedulers are ideally implemented as FPGA's (Field Programmable Gate Arrays) attached to the crosspoint router 12. In yet another implementation it is possible to incorporate both of the transfer schedulers 21 in one FPGA. A block diagram of the scheduler is shown in FIG. 10. It must be realised that it is often desirable to transfer parts or ‘windows’ (or stripes) of an image. To do this it must be possible to specify where within the source image the transference of the image data is to start. Thus parameters that are necessary to be defined before initiating a transfer include:

H Active Count for a line—the length of the part of the line that is desired to be transferred.

H Offset for a line—the start point within the source line from which to start transferring.

H total Count for a line—the total length of a line that is in the source image.

V Active count (lines) per Field—the number of lines from the source that are to be transferred.

V Offset for a field—the start line from the source image to start transferring from.

V total count for a field—the total number of lines per field present in the source image.

In the special case where H Active Count=H Total count, and H Offset=0, then the full width of the picture will be transferred. This therefore is the mechanism used to describe a ‘stripe’ for transferring. Also similarly, if V active count=V Total count, and V Offset=0, then the full height of the picture will be transferred. Obviously, if both of the above conditions are met, then the whole image will be transferred including blanking and any ancillary information within the blanking periods. These areas may include embedded audio data, timecodes, meta-data and in the case of compressed images, control information. In other cases where data transfers or non-video-locked transfers is happen, these parameters can be adjusted to guarantee a certain bandwidth availability to the various buffers for background access.

Considering FIG. 10, there are registers for H total count 22, H offset count 23, and H active count 24. Similarly there are registers for V total count 25, V Offset count 26, and V active count 27. The Microprocessor sets up the active counters 24 and 27. The total frame counter 28 is loaded with the total number of frames to be transferred and the gate combiner 29 calculates the transfer parameters to read from. A transfer counter register 30 is used to record the total number of transfers carried out. This counter 30 is incremented by one after the end of each successful transfer. This transfer counter loads one or more transfer mode registers 31, which in conjunction with signals from the controlling microprocessor load the crosspoint selector 32.

It is normally desirable to video-reference each scheduling unit to a particular I/O card. It is also desirable to enable each scheduler 21 to be capable of multiple synchronous stream transfers. This caters for two important cases. The first of these is where the two schedulers 21 reference separate IO cards using separate disc buffers for two independent transfers. The second important case is where a scheduler 21 is to drive a number (say up to four) synchronous lower bandwidth streams with similar (but not identical) paths in a ‘time slice’ manner i.e. the scheduler 21 allows one interval of time to transfer data from a first stream, and when this time interval has elapsed, to start to transfer data from a second stream for another time interval. This is repeated until one time interval has been spent on each of the existing streams, after which the next time interval is spent attending to data in the first stream again. In yet another mode it is desirable to ‘chain’ these transfers, that is to transfer all of the first stream, followed by transferring all of the second stream, and so on until all streams have been transferred. When a transfer is selected for execution, the crosspoints to be used for the route will be referred to a crosspoint arbiter 33 logical unit. The crosspoint arbiter 33 will check, from a table, whether the source and destination crosspoints are already in use. If either of them are, an error condition is declared by the arbiter 33, and this transfer suspended until both of the necessary crosspoints are found to be free. Operational software may detect the arbiter error, and issue textural messages to the operator. If no error conditions are declared by the arbiter 33 the transfer will begin. Once a transfer is complete, the scheduler 21 can generate an interrupt to the CPU, allowing it to perform any necessary boundary ‘tidy ups’ of the disc buffer data. This is necessary when the data for a scanning line crosses a boundary between disc buffers. This condition is awkward to deal with, and is preferably to be avoided.

The optimal transfer mechanism within the system architecture is via dedicated ‘point to point’ switching techniques. FIG. 11 shows a cross point switch 12 with connections from a disc system 3, an external network 35, an Input/Output card 5, and a work station bus 1. There are more preferable connections and less preferential connections across the cross point switch. For example, connections between the network 34 and the disc 3, between the disc and the Input/Output card 5 and between the network and workstation 1 are preferable to connections between the Input/Output card and the workstation which are dictated by the speed of the workstation.

In order to further improve the architectural efficiency, it is desirable to add ‘intelligence’ to the disc 3 and display sub-system. It is therefore desirable to control transfers from the disc 3 to video input-output card 35 (and vice versa) via a local processor 36 rather than the main system processor 4, as shown in FIG. 12. A video I/O card 5 is connected to the disc controller 37 which is in turn connected to the storage disc system 3. The transfers between the video Input/Output card 35 and the disc controller 37 are ‘supervised’ by a local processor 36. The video Input/Output card 35 may be a proprietary card, or a modified version of a readily available card such as the ‘Truevision Taga 2000’ card, from Pinnacle Inc, California, USA. The disc controller 37 may be for example the ‘Ultra 640’ SCSI controller from Adaptec Inc, of Milpitas, Calif. USA, and suitable processors 4 could be the Intel i960 from the Intel Corporation, of Santa Clara, Calif., USA. The disc system 3 could be of the magentic, magento-optical, or optical technology One example of a suitable disc would be the ‘Barracuda’ family of discs from Seagate Inc, of Scotts Valley, Calif. USA.

Considering now a further enhancement to the system proposed herein with reference to a practical example of a typical two hour ‘episodic’ television program. Such a program may be made and shown at ‘daily’ intervals. It may also be desired to produce the program in ‘Film resolution’, for later showing in Cinemas. A typical data rate for this film resolution data uncompressed may be 300 Mbytes per second.

Currently, the fastest readily available networks run at slightly less than 1 Gigabit per second. This includes technologies such as Gigabyte Ethernet, Fibrechannel, and HIPPI. Typical transfer rates of these networks are around 100 Mbytes per second. Note that in practice this network will be unlikely to sustain an efficiency of greater than 50% useful ‘payload’, as it is necessary to send control an verification data, checksums, and other synchronising information as well as the useful data. Thus the effective transfer rate for these types of connection are typically 50 Mbytes per second of useful picture data.

For illustrative purposes, consider the time taken to transfer a program such as the one described above at ‘Film resolution’ over a network at ‘one sixth of real time’, then the two hour program will take twelve hours to transfer. Thus more than a complete 8 hour working ‘shift’ (or 50% of the available period between episodes) will be spent in moving the program data from one place to another. Alternatively, if the program is to be mastered at only a HD resolution of 100 Mbytes per second, then the 2 hour program will still take 4 hours to transfer. These calculations clearly show that it can take substantially longer than the program running time to transfer the image data from one workstation to another. This is obviously undesirable.

The delay caused by passing the program data over the network can be avoided by providing a high speed connection from the 64 bit network card to the video I/O cross-point provider 12, as shown in FIG. 13 linking points X and Y. The high speed connection is for example an LVDS bus.

The system according to the present invention may be further enhanced by adding processing power to the real time system 2, as shown schematically in FIG. 14. A memory block 38, having four processors (A, B, C, D) attached thereto, is connected to ancillary systems by an LVDS bus. The processors (A, B, C, D) each have read and write access to the memory block 38. This architecture is particularly good at performing mathematical operations on video or motion picture data which is usually provided in a stream in which the first portion of the data describes the first frame of data, followed by data that corresponds to the second frame, and so on.

There are many desirable image enhancement algorithms that require data from a series of picture frames. Such algorithms may be for noise reduction or image coding. Such algorithms are described in Chapter 21 of ‘Digital Image Processing’ by William K Pratt, published by John Wiley & Sons in 1978, ISBN 0-471-01888-0. The architecture we have illustrated in FIG. 14 is particularly suited to these types of algorithm as the processors may work the video or motion picture frames as set out below:

| | | |
|---|---|---|
| Processor A | Frames | 1, 2, 3, 4 |
| Processor B | Frames | 2, 3, 4 ,5 |
| Processor C | Frames | 3, 4, 5, 6 |
| Processor D | Frames | 4, 5, 6, 7 |

It will be obvious to one skilled in the art that this architecture can have N processors, and this will have access to N frames of video. Another architecture that can be utilised for other classes of algorithms is to process as follows:

| | | |
|---|---|---|
| Processor A | Frames | 1, 5, 9, 13 |
| Processor B | Frames | 2, 6, 10, 14 |
| Processor C | Frames | 3, 7, 11, 15 |
| Processor D | Frames | 4, 8, 12, 16 |

The above embodiments of the present invention have been described with reference to the RAID 3 standard of data formatting It will be appreciated by those skilled in the art that other standard RAID formats may be utilised, for example RAID 5 whereby the parity information is not stored on a single disc, rather it is stored in blocks on each disc in the array. Alternative embodiments include the use of fibre channel or other disc control systems.

It will be appreciated that once on disc, ‘playout’ conversions of images stored in the common image format (1920×1080) can be replayed at user selected data rates. This may include, for example, the playout of images from the 24P (progressive) to 301 (Interlace).

The packing or unpacking process may contain one or more additional transformation processes. Such additional processes may include in the conversion from one colour to another. One example of this is the conversion from Red, Green and Blue to the ‘Yuv@ colour space. Alternatively, the additional process could be to produce a simultaneous ‘image and key’ signal from separate files. This would involve the ‘interleaving’ of the ‘key’ signal into an R, G, P stream to produce an R, G, B, Key signal. Data compression techniques can also be one of these additional processes. These data compression processes may include lossless compression such as the ‘LZW’ (Lempl-Ziv-Welch) algorithm, or ‘lossy’ techniques such as the JPEG or MPEG techniques.

It will be appreciated that the present invention also extends to computer software to be run on the data processing apparatus described herein to control the handling and manipulation of the data and/or the controlling of transfers to and from the discs. The computer software may be provided in any desired form such as embedded chips, or supplied on a carrier such as a CD-ROM, or supplied from a remote location, for example over the Internet or another suitable network or communications link.

Although the present invention has been described with reference to preferred embodiments, persons skilled in the art will recognize that changes may be made in form and detail without departing from the spirit and scope of the invention.

What is claimed is:

1. A method of processing video data comprising the sequential steps of;
(a) transferring the video data to a first memory buffer and manipulating said video data;
(c) transferring said manipulated video data to a second memory buffer; and
(d) writing said manipulated video data to a plurality of discs.

2. A method of processing video data as claimed in claim 1, wherein the video data transferred to the first memory buffer is in the form of two interlaced fields and said interlaced fields are combined and stored sequentially in said first memory buffer.

3. A method of processing video data as claimed in claim 1, wherein the manipulation of said video data comprises dividing said video data into a plurality of blocks, and the transferral of said manipulated data to the second memory buffer comprises transferring said blocks to a plurality of disc stripe buffers in said second memory buffer such that consecutive blocks are not grouped in the same disc stripe buffer.

4. A method of processing video data as claimed in claim 3, wherein a series of consecutive blocks of said video data is transferred to the second memory buffer such that each block in the series is transferred to a different disc stripe buffer and the number of blocks in the series is the same as the number of disc stripe buffers.

5. A method of processing video data as claimed in claim 3, wherein the disc stripe buffers are filled consecutively.

6. A method of processing video data as claimed in claim 5, wherein each disc stripe buffer is written to one of said plurality of discs when it is full.

7. A method of processing video data as claimed in claim 1, wherein the step of manipulating said video data comprises generating parity data of the video data, and said parity data is transferred to a parity buffer in said second memory buffer and written to a parity disc.

8. A method of processing video data as claimed in claim 1, wherein said video data is packed into consecutive bytes to reduce the number of empty bits of information.

9. A method of processing video data as claimed in claim 1, wherein said first memory buffer is SRAM and the second memory buffer is SDRAM.

10. A method of processing video data as claimed in claim 1, wherein the video data transferred to the first memory buffer is a stripe of a video image, and a plurality of said stripes make up the video image.

11. A method of processing video data as claimed in claim 1, wherein the video data corresponds to a High Definition video image and the synchronization and blanking pulses are removed from the image to allow the video data to fit into a standard computer PCI bus bandwidth.

12. A method of processing video data comprising extracting video data from a plurality of discs, wherein said video data has been manipulated and written to said discs in accordance with claim 1.

13. A method of processing video data as claimed in claim 12, wherein the playout rate of the video data extracted from said plurality of discs is different from that of the video data written to said discs.

14. Data processing apparatus having a first memory buffer, a second memory buffer, means for manipulating video data, a plurality of discs, a disc writing means, and controlling means for controlling the data processing apparatus so that it carries out the method of claim 1.

15. Software for use on data processing apparatus as claimed in claim 14, the software being such that when used it will cause the data processing apparatus to carry out the method of claim 1.

16. A method of processing video data comprising the sequential steps of:
(a) transferring the video data to a first memory buffer and manipulating said video data comprising dividing said video data into a plurality of blocks;
(b) and transferring said plurality of blocks to a plurality of disc stripe buffers in a second memory buffer such that consecutive blocks are not grouped in the same disc stripe buffer; and
(c) writing said manipulated video data in said plurality of disc stripe buffers to a plurality of discs.

17. A method of processing video data comprising extracting video data from a plurality of discs, wherein said video data has been manipulated and written to said discs in accordance with claim 16.

18. A method of extracting video data from a plurality of discs comprising the sequential steps of:
(a) accessing manipulated video data on said plurality of discs;
(b) transferring said manipulated video data to a second memory buffer;
(c) converting said manipulated video data into video data and transferring the video data to a first memory buffer.

19. A method of processing video data as claimed in claim 18, wherein the playout rate of the video data extracted from said plurality of discs is different from that of the video data written to said discs.

20. Data processing apparatus having disc accessing means, a first memory buffer, a second memory buffer, conversion means for converting the manipulated video data into video data, a plurality of discs, and controlling means for controlling the data processing apparatus so that it carries out the method of claim 18.

21. Software for use on data processing apparatus as claimed in claim 20, the software being such that when used it will cause the data processing apparatus to carry out the method of claim 18.

22. A method of processing video data comprising the steps of dividing a video image into a series of stripes which are each transferred to a separate first memory buffer which is connected to a plurality of disc drives.

23. Data processing apparatus having dividing means for dividing a video image into a series of stripes, a separate first memory buffer, a plurality of discs, and controlling means for controlling the data processing apparatus so that it carries out the method of claim 22.

24. Software for use on data processing apparatus as claimed in claim 23, the software being such that when used it will cause the data processing apparatus to carry out the method of claim 22.
